(19) United States
(12) Patent Application Publication
(10) Pub. No.: US 2023/0266685 A1
(43) Pub. Date: Aug. 24, 2023

(54) ELECTROPHOTOGRAPHIC PHOTOSENSITIVE MEMBER, PROCESS CARTRIDGE, AND IMAGE FORMING APPARATUS

(71) Applicant: FUJIFILM Business Innovation Corp., Tokyo (JP)

(72) Inventors: Eri KUNISAWA, Kanagawa (JP); Hiroaki OGAWA, Kanagawa (JP)

(73) Assignee: FUJIFILM Business Innovation Corp., Tokyo (JP)

(21) Appl. No.: 17/939,450

(22) Filed: Sep. 7, 2022

(30) Foreign Application Priority Data
Feb. 18, 2022 (JP) 2022-024156

(51) Int. Cl. G03G 5/147; G03G 21/18; G03G 5/047

(52) U.S. Cl. CPC G03G 5/14769; G03G 21/1814; G03G 5/047

(57) ABSTRACT

An electrophotographic photosensitive member includes a conductive support having a thickness of 3 mm or more, a photosensitive layer disposed on the conductive support, and a surface protection layer disposed on the photosensitive layer, in which the surface protection layer is a layer composed of a film formed by curing a composition including a reactive group-containing charge transporting material including a reactive group and a charge transporting skeleton in the same molecule, or a film formed by curing a composition including an unreactive charge transporting material and a reactive group-containing non-charge transporting material that does not include a charge transporting skeleton and includes a reactive group, and the ratio of the degree of cure of the conductive support-side surface of the surface protection layer which faces the conductive support to the degree of cure of the outer periphery-side surface of the surface protection layer which serves as the outer periphery is 75% or more.

### CROSS-REFERENCE TO RELATED APPLICATIONS

This application is based on and claims priority under 35 USC 119 from Japanese Patent Application No. 2022-024156 filed Feb. 18, 2022.

### BACKGROUND

### (i) Technical Field

The present disclosure relates to an electrophotographic photosensitive member, a process cartridge, and an image forming apparatus.

### (ii) Related Art

Japanese Patent No. 4208731 discloses an electrophotographic image forming method in which the rotation speed of a photosensitive member is 60 rpm or more, wherein a cylindrical electrophotographic photosensitive member that includes a binder resin having a specific repeating structure and an organic photoconductor is used as a photosensitive member. The amount R of residual deformation of the organic photoconductor which is measured in an indentation test is 50% or less.

Japanese Laid Open Patent Application Publication No. 2019-184810 discloses an electrophotographic photosensitive member that includes a conductive support and a single-layer photosensitive layer disposed on the conductive support, the photosensitive layer including a binder resin, a charge generating material, a hole transporting material, and an electron transporting material. The Martens hardness a [N/mm²], Young's modulus b [MPa], and elastic deformation ratio c [%] of the surface of the photosensitive layer which are measured in a 23° C./30RH % environment satisfy the following formula:

−4.1≤Y≤−3.1,

where Y=0.06×a−0.0018×b−0.19×c (1)

Japanese Laid Open Patent Application Publication No. 2005-351954 discloses an electrophotographic photosensitive member that includes a conductive support and a photosensitive layer and a surface protection layer that are disposed on the conductive support. The photosensitive layer has a thickness of 5 μm or more and 15 μm or less. The HU value of the photosensitive member which is determined when indentation is performed at a maximum load of 6 mN using a Vickers quadrangular pyramidal diamond indenter in a hardness test at a temperature of 25° C. and a humidity of 50% is 150 N/mm² or more and 220 N/mm² or less. The elastic deformation ratio of the photosensitive member is 50% or more and 65% or less.

### SUMMARY

In an electrophotographic photosensitive member that includes a conductive support having a thickness of 3 mm or more, the conductive support-side surface of a surface protection layer is more likely to wear than the outer periphery-side surface thereof and abrasion resistance may vary over a long period of time.

Aspects of non-limiting embodiments of the present disclosure relate to an electrophotographic photosensitive member that includes a conductive support having a thickness of 3 mm or more, a photosensitive layer, and a surface protection layer composed of a film formed by curing a composition including a charge transporting material, the electrophotographic photosensitive member reducing the long-term variations in the abrasion resistance of the surface protection layer compared with the case where the ratio of the degree of cure of the conductive support-side surface of the surface protection layer to the degree of cure of the outer periphery-side surface of the surface protection layer is less than 75%.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrophotographic photosensitive member including: a conductive support having a thickness of 3 mm or more; a photosensitive layer disposed on the conductive support; and a surface protection layer disposed on the photosensitive layer, wherein the surface protection layer is a layer composed of a film formed by curing a composition including a reactive group-containing charge transporting material, the reactive group-containing charge transporting material including a reactive group and a charge transporting skeleton in a same molecule, or a film formed by curing a composition including an unreactive charge transporting material and a reactive group-containing non-charge transporting material, the reactive group-containing non-charge transporting material not including a charge transporting skeleton and including a reactive group, and wherein a ratio of a degree of cure of a conductive support-side surface of the surface protection layer, the conductive support-side surface facing the conductive support, to a degree of cure of an outer periphery-side surface of the surface protection layer, the outer periphery-side surface serving as an outer periphery of the electrophotographic photosensitive member, is 75% or more.

### BRIEF DESCRIPTION OF THE DRAWINGS

Exemplary embodiments of the present disclosure will be described in detail based on the following figures, wherein:

FIG. 1 is a schematic partial cross-sectional view of an electrophotographic photosensitive member according to an exemplary embodiment, illustrating an example of the structure of layers constituting the electrophotographic photosensitive member;

FIG. 2 is a schematic diagram illustrating an example of an image forming apparatus according to an exemplary embodiment; and

FIG. 3 is a schematic diagram illustrating another example of the image forming apparatus according to the exemplary embodiment.

### DETAILED DESCRIPTION

Exemplary embodiments of the present disclosure are described below. The following description and Examples below are intended to be illustrative of the exemplary embodiments and not restrictive of the scope of the exemplary embodiments.

In the present disclosure, a numerical range expressed using “to” means the range specified by the lower and upper limits described before and after “to”, respectively.

In the present disclosure, when numerical ranges are described in a stepwise manner, the upper or lower limit of a numerical range may be replaced with the upper or lower limit of another numerical range, respectively. In the present disclosure, the upper and lower limits of a numerical range may also be replaced with the values described in Examples below.

In the present disclosure, the term “step” refers not only to an individual step but also to a step that is not distinguishable from other steps but achieves the intended purpose of the step.

In the present disclosure, each of the components may include a plurality of types of substances that correspond to the component. In the present disclosure, in the case where a composition includes a plurality of substances that correspond to a component of the composition, the content of the component in the composition is the total content of the substances in the composition unless otherwise specified.

In the present disclosure, the term “principal component” refers to, for example, a component of a mixture that includes a plurality of components the amount of which is 30% by mass or more of the total mass of the mixture.

In the present disclosure, the electrophotographic photosensitive member is also referred to simply as “photosensitive member”.

### Electrophotographic Photosensitive Member

A photosensitive member according to this exemplary embodiment includes a conductive support, an undercoat layer disposed on the conductive support, a photosensitive layer disposed on the undercoat layer, and a surface protection layer disposed on the photosensitive layer.

The structure of layers constituting the electrophotographic photosensitive member according to this exemplary embodiment is described below with reference to the attached drawings.

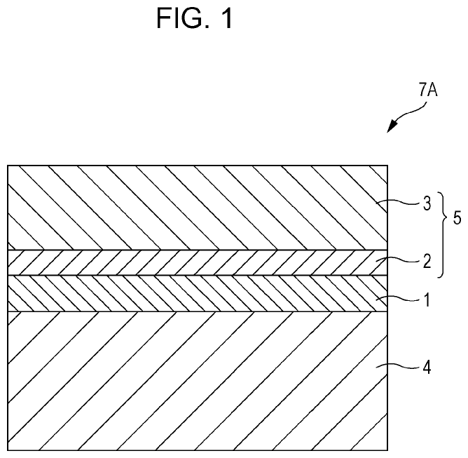

FIG. 1 is a schematic cross-sectional view of an electrophotographic photosensitive member according to this exemplary embodiment, illustrating an example of the structure of layers constituting the electrophotographic photosensitive member.

The photosensitive member 7A illustrated in FIG. 1 includes a conductive support 4, an undercoat layer 1 disposed on the conductive support 4, a charge generation layer 2 disposed on the undercoat layer 1, and a charge transport layer 3 disposed on the charge generation layer 2. The charge generation layer 2 and the charge transport layer 3 constitute a photosensitive layer 5. Although not illustrated in the drawing, the photosensitive member 7A further includes a surface protection layer 6 disposed on the charge transport layer 3. The surface protection layer 6 is a layer composed of a film formed by curing a composition including a charge transporting material or a layer composed of a film formed by curing a composition including an unreactive charge transporting material and a reactive group-containing non-charge transporting material that does not include a charge transporting skeleton and includes a reactive group. The ratio of the degree of cure of the conductive support-side surface of the surface protection layer 6 to the degree of cure of the outer periphery-side surface of the surface protection layer 6 is 75% or more.

The photosensitive layer included in the photosensitive member according to this exemplary embodiment may be either a separated-function photosensitive layer that includes a charge generation layer 2 and a charge transport layer 3 in a separated manner as in the photosensitive member 7A illustrated in FIG. 1 or a single-layer photosensitive layer that has both charge generating ability and charge transporting ability instead of including the charge generation layer 2 and the charge transport layer 3. In the case where the photosensitive layer is a multilayer photosensitive layer, the order in which the charge generation layer and the charge transport layer are arranged is not limited. The electrophotographic photosensitive member may have a structure including a conductive support, a charge generation layer disposed on the conductive support, a charge transport layer disposed on the charge generation layer, and a surface protection layer disposed on the charge transport layer. The electrophotographic photosensitive member may include a layer other than any of the above layers.

The electrophotographic photosensitive member according to this exemplary embodiment is described in detail below. Note that the reference numerals are omitted hereinafter.

The electrophotographic photosensitive member according to this exemplary embodiment includes a conductive support having a thickness of 3 mm or more, a photosensitive layer disposed on the conductive support, and a surface protection layer disposed on the photosensitive layer. The surface protection layer is composed of a film formed by curing a composition including a reactive group-containing charge transporting material including a reactive group and a charge transporting skeleton in the same molecule, or a film formed by curing a composition including an unreactive charge transporting material and a reactive group-containing non-charge transporting material that does not include a charge transporting skeleton and includes a reactive group. The ratio of the degree of cure of the conductive support-side surface of the surface protection layer which faces the conductive support to the degree of cure of the outer periphery-side surface of the surface protection layer which serves as the outer periphery of the electrophotographic photosensitive member is 75% or more.

In a photosensitive member that includes a conductive support having a thickness of 3 mm or more, the conductive support has a larger heat capacity and heat is less likely to transfer to the conductive support-side (i.e., inner periphery-side) part of a photosensitive member on which a surface protection layer has not been formed, than in a photosensitive member that includes a conductive support having a thickness of less than 3 mm. Therefore, in the formation of the surface protection layer, heat is unlikely to transfer from the outer periphery-side part of the surface protection layer toward the conductive support-side part of the surface protection layer. Accordingly, the difference in the degree of cure of the cured film between the outer periphery-side part and the conductive support-side part is likely to be increased. If an image is repeatedly formed using a photosensitive member in which the ratio of the degree of cure of the conductive support-side surface to the degree of cure of the outer periphery-side surface is low, the abrasion loss of the surface protection layer per revolution of the photosensitive member becomes gradually increased. This phenomenon is significant in the case where the surface protection layer is composed of a film formed by curing the above-described composition. In particular, when the photosensitive member is used over a long period of time, the abrasion resistance of the surface protection layer is likely to vary.

If the abrasion resistance of the surface protection layer varies as described above, the detachment of the surface protection layer may occur at an early stage over time and the detached portions appear as dot-like image quality defects.

On the other hand, in the photosensitive member according to this exemplary embodiment, the ratio of the degree of cure of the conductive support-side surface of the surface protection layer to the degree of cure of the outer periphery-side surface of the photosensitive member is 75% or more. In other words, the difference in the degree of cure of the cured film between the outer periphery-side part and the conductive support-side part is limited to be small. Therefore, even when an image is repeatedly formed using this photosensitive member, variations in the abrasion loss of the surface protection layer per revolution of the photosensitive member may be limited to be small. As a result, it is considered that long-term variations in the abrasion resistance of the surface protection layer may be limited even in the case where the photosensitive member includes a conductive support having a thickness of 3 mm or more and a surface protection layer composed of a film formed by curing the above-described composition. It is considered that this also reduces the likelihood of the surface protection layer detaching at an early stage and the likelihood of dot-like image quality defects being caused at an early stage due to the detached portions.

Details of each of the layers constituting the photosensitive member according to this exemplary embodiment are described below.

### Surface Protection Layer

The surface protection layer is disposed on the photosensitive layer.

The surface protection layer is a layer composed of a film formed by curing a composition including a reactive group-containing charge transporting material that includes a reactive group and a charge transporting skeleton in the same molecule or a layer composed of a film formed by curing a composition including an unreactive charge transporting material and a reactive group-containing non-charge transporting material that does not include a charge transporting skeleton and includes a reactive group. The ratio of the degree of cure of the conductive support-side surface of the surface protection layer to the degree of cure of the outer periphery-side surface of the surface protection layer is 75% or more.

The ratio of the degree B of cure of the conductive support-side surface of the surface protection layer to the degree A of cure of the outer periphery-side surface of the surface protection layer (=B/A×100) is 75% or more, is preferably 80% or more and 100% or less, and is more preferably 90% or more and 100% or less.

When the above ratio is 75% or more (preferably 80% or more and 100% or less), that is, the difference in the degree of cure of the cured film between the outer periphery-side part and the conductive support-side part is limited to be small, variations in the abrasion loss of the surface protection layer per revolution of the photosensitive member may be limited to be small and long-term variations in the abrasion resistance of the surface protection layer may be reduced.

The degree A of cure of the outer periphery-side surface of the surface protection layer is preferably 55% or more and 95% or less, is more preferably 68% or more and 88% or less, and is further preferably 74% or more and 82% or less.

When the degree A of cure of the outer periphery-side surface is 55% or more, the hardness of the outer periphery-side surface is not reduced to an excessive degree and the abrasion resistance of the surface protection layer may be further enhanced. When the degree A of cure of the outer periphery-side surface is 95% or less, the hardness of the outer periphery-side surface is not increased to an excessive degree and the difference in the degree of cure of the cured film between the outer periphery-side part and the conductive support-side part may be limited to be further small. Accordingly, variations in the abrasion loss of the surface protection layer per revolution of the photosensitive member may be limited to be small. As a result, long-term variations in the abrasion resistance of the surface protection layer may be further reduced.

The degree B of cure of the conductive support-side surface of the surface protection layer is preferably 41% or more and 95% or less, is more preferably 54% or more and 88% or less, and is further preferably 67% or more and 82% or less.

When the degree A of cure of the outer periphery-side surface is 55% or more, the hardness of the conductive support-side surface is not reduced to an excessive degree, the hardness of the outer periphery-side surface is not reduced to an excessive degree, and the abrasion resistance of the surface protection layer may be further enhanced. When the degree B of cure is 41% or more, the difference in the degree of cure of the cured film between the outer periphery-side part and the conductive support-side part is limited to be further small. Accordingly, variations in the abrasion loss of the surface protection layer per revolution of the photosensitive member may be limited to be small. As a result, long-term variations in the abrasion resistance of the surface protection layer may be further reduced.

When the degree B of cure of the conductive support-side surface is 95% or less, the hardness of the outer periphery-side surface is not reduced to an excessive degree and the difference in the degree of cure of the cured film between the outer periphery-side part and the conductive support-side part is limited to be further small. Accordingly, variations in the abrasion loss of the surface protection layer per revolution of the photosensitive member may be limited to be small. As a result, long-term variations in the abrasion resistance of the surface protection layer may be further reduced.

The method for controlling the degree of cure of the outer periphery-side surface, the degree of cure of the conductive support-side surface, and the ratio therebetween is not limited. For example, a hot-air drying step (e.g., performing heating at a temperature of 155° C. or more for 15 minutes or more) may be conducted in the formation of the surface protection layer.

The degree of cure is measured in the following manner.

(1) The photosensitive member is cut diagonally in the direction from the surface of the photosensitive member to the support such that the conductive support-side part is exposed at the surface without separation of the surface protection layer to prepare a 20 mm×20 mm specimen.

(2) The proportion of curing reaction groups that remain in each of the outer periphery-side surface and the conductive support-side surface of the specimen is measured by infrared absorption spectroscopy under the following conditions.

Measurement conditions: Infrared absorption spectroscopy device produced by PerkinElmer

Measurement conditions: ATR (Ge) method, area ratio between the absorption peak corresponding to the wavelength at which the curing reaction groups are detected and the absorption peak corresponding to the base wavelength

The surface protection layer is a layer described in 1) or 2) below.

When the surface protection layer is the layer described in 1) or 2) below, the chemical change of the photosensitive layer which may occur during charging may be reduced. Furthermore, the abrasion resistance of the surface protection layer may be enhanced.

1) a layer composed of a film formed by curing a composition including a reactive group-containing charge transporting material that includes a reactive group and a charge transporting skeleton in the same molecule, that is, a layer including a polymer or a crosslinked product of the reactive group-containing charge transporting material.

2) a layer composed of a film formed by curing a composition including an unreactive charge transporting material and a reactive group-containing non-charge transporting material that does not include a charge transporting skeleton and includes a reactive group, that is, a layer including a polymer or a crosslinked product of the unreactive charge transporting material with the reactive group-containing non-charge transporting material.

The layer described in 1) above may further include an unreactive charge transporting material in the composition.

Examples of the reactive group included in the reactive group-containing charge transporting material include the following known reactive groups: a chain-polymerization group; an epoxy group; a —OH group; a —OR group, where R is an alkyl group; a —NH₂ group; a —SH group; a —COOH group; and a —SiRQ¹_{3-Qn}(OR^{Q2})_{Qn} group, where R^{Q1} represents a hydrogen atom, an alkyl group, an aryl group, or a substituted aryl group, R^{Q2} represents a hydrogen atom, an alkyl group, or a trialkylsilyl group, and Qn is an integer of 1 to 3. Examples of the reactive group included in the reactive group-containing non-charge transporting material also include the known reactive groups described above.

The chain-polymerization group is not limited, and may be any functional group capable of inducing radical polymerization. Examples of the chain-polymerization group include functional groups including at least a carbon double bond. Specific examples of the chain-polymerization group include functional groups including at least one selected from a vinyl group, a vinyl ether group, a vinylthioether group, a styryl group, an acryloyl group, a methacryloyl group, and derivatives of the above groups. In particular, a chain-polymerization group including at least one selected from a vinyl group, a styryl group (i.e., a vinylphenyl group), an acryloyl group, a methacryloyl group, and derivatives of the above groups may be used, because such a chain-polymerization group has high reactivity.

The charge transporting skeleton is not limited and may be any charge transporting skeleton having a structure known in the field of image holding members. Examples of such a charge transporting skeleton include skeletons that are derived from nitrogen-containing hole transporting compounds, such as triarylamine compounds (i.e., compounds having a triarylamine skeleton), benzidine compounds (i.e., compounds having a benzidine skeleton), and hydrazone compounds (i.e., compounds having a hydrazone skeleton) and conjugated with a nitrogen atom. Among these, a charge transporting skeleton having a triarylamine skeleton may be used.

The above-described reactive group-containing charge transporting material that includes the reactive group and the charge transporting skeleton, the unreactive charge transporting material, and the reactive group-containing non-charge transporting material may be selected from known materials.

The reactive group-containing charge transporting material may be a reactive group-containing charge transporting material that includes a chain polymerization group that serves as a reactive group (hereinafter, also referred to as “specific reactive group-containing charge transporting material (a)”). Only one reactive group-containing non-charge transporting material may be used alone. Alternatively, two or more reactive group-containing non-charge transporting materials may be used in combination.

The specific reactive group-containing charge transporting material (a) may be the compound represented by General Formula (A) below in order to enhance charge transporting ability.

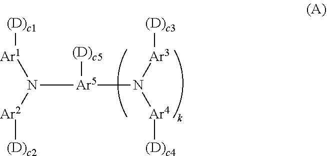

In General Formula (A) above, Ar¹ to Ar⁴ each independently represent a substituted or unsubstituted aryl group; Ar⁵ represents a substituted or unsubstituted aryl group or a substituted or unsubstituted arylene group; D represents an organic group having a chain polymerization group; c1 to c5 each independently represent an integer of 0 to 2; k represents 0 or 1; d represents an integer of 0 to 5; e represents 0 or 1; and the total number of D's is 4 or more.

In General Formula (A), Ar¹ to Ar⁴ each independently represent a substituted or unsubstituted aryl group. Ar¹ to Ar⁴ may be the same as or different from one another.

Examples of the substituent included in the substituted aryl group which are other than D: an organic group having a chain polymerization group include an alkyl or alkoxy group having 1 to 4 carbon atoms and a substituted or unsubstituted aryl group having 6 to 10 carbon atoms.

Ar¹ to Ar⁴ may be any of Formulae (1) to (7) below. Note that Formulae (1) to (7) below are expressed with “-(D)_{C}”, which refers collectively to “-(D)_{C1}” to “-(D)_{C4}” that may be bonded to Ar¹ to Ar⁴, respectively.

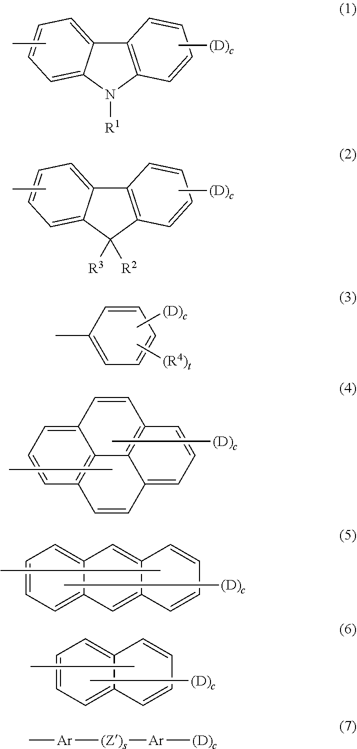

In Formulae (1) to (7) above, R¹ represents one selected from the group consisting of a hydrogen atom, an alkyl group having 1 to 4 carbon atoms, a phenyl group substituted with an alkyl group having 1 to 4 carbon atoms or an alkoxy group having 1 to 4 carbon atoms, an unsubstituted phenyl group, and an aralkyl group having 7 to 10 carbon atoms; R² to R⁴ each independently represent one selected from the group consisting of a hydrogen atom, an alkyl group having 1 to 4 carbon atoms, an alkoxy group having 1 to 4 carbon atoms, a phenyl group substituted with an alkoxy group having 1 to 4 carbon atoms, an unsubstituted phenyl group, an aralkyl group having 7 to 10 carbon atoms, and a halogen atom; Ar represents a substituted or unsubstituted arylene group; D represents an organic group having a chain polymerization group; c represents 1 or 2; s represents 0 or 1; and t represents an integer of 0 to 3.

In Formula (7), Ar may be the group represented by Structural Formula (8) or (9) below.

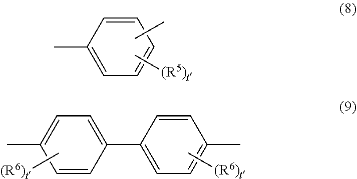

In Formulae (8) and (9) above, R⁵ and R⁶ each independently represent one selected from the group consisting of a hydrogen atom, an alkyl group having 1 to 4 carbon atoms, an alkoxy group having 1 to 4 carbon atoms, a phenyl group substituted with an alkoxy group having 1 to 4 carbon atoms, an unsubstituted phenyl group, an aralkyl group having 7 to 10 carbon atoms, and a halogen atom; and t′ represents an integer of 0 to 3.

In Formula (7) above, Z′ represents a divalent organic linking group. Z′ may be the group represented by any of Formulae (10) to (17) below. In Formula (7) above, s represents 0 or 1.

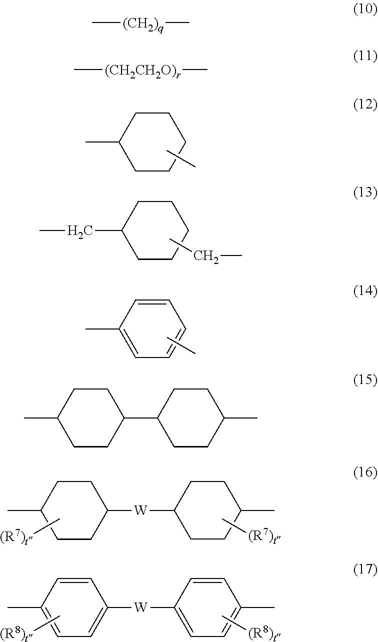

In Formulae (10) to (17) above, R⁷ and R⁸ each independently represent one selected from the group consisting of a hydrogen atom, an alkyl group having 1 to 4 carbon atoms, an alkoxy group having 1 to 4 carbon atoms, a phenyl group substituted with an alkoxy group having 1 to 4 carbon atoms, an unsubstituted phenyl group, an aralkyl group having 7 to 10 carbon atoms, and a halogen atom; W represents a divalent group; q and r each independently represent an integer of 1 to 10; and t″ each independently represent an integer of 0 to 3.

In Formulae (16) and (17) above, W may be any of the divalent groups represented by Formulae (18) to (26) below. In Formula (25), u represents an integer of 0 to 3.

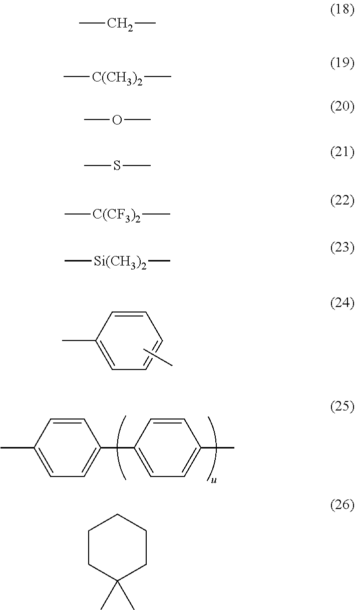

In General Formula (A), when k is 0, Ar⁵ is a substituted or unsubstituted aryl group. Examples of the aryl group include the aryl groups described as examples in the description of Ar¹ to Ar⁴. When k is 1, Ar⁵ is a substituted or unsubstituted arylene group. Examples of the arylene group include arylene groups formed by removing one hydrogen atom from the respective aryl groups described as examples in the description of Ar¹ to Ar⁴ which is located at a position at which —N(Ar³-(D)_{c3})(Ar⁴-(D)_{C4}) is to be bonded.

The content of the reactive group-containing charge transporting material is preferably 30% by mass or more and 100% by mass or less, is more preferably 40% by mass or more and 100% by mass or less, and is further preferably 50% by mass or more and 100% by mass or less of the amount (solid content) of the composition used for forming the surface protection layer. Limiting the above content to fall within the above range enhances the electric characteristics of the cured film and allows the thickness of the cured film to be increased.

Examples of the unreactive charge transporting material include the following electron-transporting compounds: quinone compounds, such as p-benzoquinone, chloranil, bromanil, and anthraquinone; tetracyanoquinodimethane compounds; fluorenone compounds, such as 2,4,7-trinitrofluorenone; xanthone compounds; benzophenone compounds; cyanovinyl compounds; and ethylene compounds. Examples of the charge transporting material also include the following hole-transporting compounds: triarylamine compounds, benzidine compounds, arylalkane compounds, aryl-substituted ethylene compounds, stilbene compounds, anthracene compounds, and hydrazone compounds. The above unreactive charge transporting materials may be used alone or in combination of two or more.

Examples of the reactive group-containing non-charge transporting material include a thermosetting resin and a curing agent. Only one reactive group-containing non-charge transporting material may be used alone. Two or more types of reactive group-containing non-charge transporting materials may be used in combination.

Examples of the thermosetting resin include a guanamine resin, a melamine resin, a phenolic resin, a urea resin, and an alkyd resin.

Examples of the curing agent include a compound having a guanamine structure (hereinafter, also referred to as “guanamine compound”) and a compound having a melamine structure (hereinafter, also referred to as “melamine compound”).

In the case where the surface protection layer is, for example, a cured film composed of the product of crosslinking between a reactive group-containing charge transporting material and at least one selected from a thermosetting resin (e.g., a guanamine resin or a melamine resin), a guanamine compound, and a melamine compound, the degree of cure of the cured film is likely to be high and abrasion resistance may be further enhanced, compared with the case where the cured film does not include a thermosetting resin (e.g., a guanamine resin or a melamine resin), a guanamine compound, and a melamine compound.

Among the layers described in 1) and 2) above, the surface protection layer is preferably the layer 1) composed of a cured product of a composition that includes a reactive group-containing charge transporting material that includes a reactive group and a charge transporting skeleton in the same molecule. When the surface protection layer is the layer described in 1) above, the hardness of the surface protection layer is further increased and abrasion resistance may be enhanced compared with the layer described in 2) above.

Fluororesin Particles

The surface protection layer may further include fluororesin particles.

When the surface protection layer includes fluororesin particles, adequate irregularities are formed in the outer periphery of the surface protection layer and abrasion resistance may be further enhanced.

The content of the fluororesin particles in the surface protection layer is 5% by mass or more and 15% by mass or less of the total solid content of the surface protection layer.

The content of the fluororesin particles is desirably 5% by mass or more and 15% by mass or less and is more desirably 7% by mass or more and 12% by mass or less of the amount (total solid content) of all the components constituting the layer.

Examples of the fluororesin particles include, but are not limited to, particles of the following resins: polytetrafluoroethylene (PTFE; also known as “tetrafluoroethylene resin”), a perfluoroalkoxyfluororesin, polychlorotrifluoroethylene, polyvinylidene fluoride, polydichlorodifluoroethylene, a tetrafluoroethylene-perfluoroalkyl vinyl ether copolymer, a tetrafluoroethylene-hexafluoropropylene copolymer, a tetrafluoroethylene-ethylene copolymer, a tetrafluoroethylene-hexafluoropropylene-perfluoroalkyl vinyl ether copolymer, and a tetrafluoroethylene-perfluoroalkoxyethylene copolymer.

Among these, polytetrafluoroethylene and a copolymer of tetrafluoroethylene and perfluoroalkoxyethylene are desirable in consideration of the abrasion resistance and ease of cleaning of the electrophotographic photosensitive member.

The above fluororesin particles may be used alone or in combination of two or more.

The weight average molecular weight of the fluororesin constituting the fluororesin particles may be, for example, 3,000 or more and 5,000,000 or less.

The average primary particle size of the fluororesin particles is desirably, for example, 0.05 μm or more and 10 μm or less and is more desirably 0.1 μm or more and 5 μm or less.

The average primary particle size of the fluororesin particles is the value determined by measuring a test liquid diluted with a solvent that is the same as that included in a dispersion liquid containing the fluororesin particles dispersed therein with a laser diffraction-scattering particle size distribution analyzer LA-920 produced by HORIBA, Ltd. at a refractive index of 1.35.

Examples of commercial products of the fluororesin particles include LUBRON (registered trademark) series produced by Daikin Industries, Ltd.; Teflon (registered trademark) series produced by Du Pont; and Dyneon series produced by Sumitomo 3M Limited.

Method for Forming Surface Protection Layer

The method for forming the surface protection layer is not limited, and known methods may be used. The surface protection layer may be formed by, for example, forming a coating film using a coating liquid prepared by mixing the above-described components in a solvent (hereinafter, this coating liquid is referred to as “surface protection layer-forming coating liquid”), drying the coating film, and, as needed, curing the coating film by heating or the like.

Examples of the solvent used for preparing the surface protection layer-forming coating liquid include aromatic solvents, such as toluene and xylene; ketone solvents, such as methyl ethyl ketone, methyl isobutyl ketone, and cyclohexanone; ester solvents, such as ethyl acetate and butyl acetate; ether solvents, such as tetrahydrofuran and dioxane; cellosolve solvents, such as ethylene glycol monomethyl ether; and alcohol solvents, such as isopropyl alcohol and butanol. The above solvents may be used alone or in a mixture of two or more.

For applying the surface protection layer-forming coating liquid on the photosensitive layer (e.g., the charge transport layer), for example, the following common methods may be used: dip coating, push coating, wire bar coating, spray coating, blade coating, knife coating, and curtain coating.

Thickness

The thickness of the surface protection layer is preferably, for example, 1 μm or more and 20 μm or less and is more preferably 2 μm or more and 10 μm or less.

### Conductive Support

The thickness of the conductive support included in the photosensitive member according to this exemplary embodiment is 3 mm or more, may be 4 mm or more and 20 mm or less, and may be 4 mm or more and 10 mm or less.

As described above, when the thickness of the conductive support is 3 mm or more (in particular, 4 mm or more and 10 mm or less), heat is unlikely to transfer from the outer periphery-side part of the surface protection layer toward the conductive support-side part of the surface protection layer in the formation of the surface protection layer, compared with a photosensitive member that includes a conductive support having a thickness of less than 3 mm. This increases the difference in the degree of cure of the cured film between the outer periphery-side part and the conductive support-side part. Consequently, the abrasion loss of the surface protection layer per revolution of the photosensitive member becomes gradually increased. As a result, long-term variations in the abrasion resistance of the surface protection layer may be increased. In contrast, in the photosensitive member according to this exemplary embodiment, the difference in the degree of cure of the cured film between the outer periphery-side part and the conductive support-side part is limited to be small in the formation of the surface protection layer, even when the thickness of the conductive support is 3 mm or more (in particular, 4 mm or more and 10 mm or less). This reduces long-term variations in the abrasion resistance of the surface protection layer.

Examples of the conductive support include a metal sheet, a metal drum, and a metal belt that are made of a metal such as aluminum, copper, zinc, chromium, nickel, molybdenum, vanadium, indium, gold, or platinum or an alloy such as stainless steel. Other examples of the conductive support include a paper sheet, a resin film, and a belt on which a conductive compound such as a conductive polymer or indium oxide, a metal such as aluminum, palladium, or gold, or an alloy is deposited by coating, vapor deposition, or lamination. The term “conductive” used herein refers to having a volume resistivity of less than 10¹³ Ωcm.

In the case where the electrophotographic photosensitive member is used as a component of a laser printer, the surface of the conductive support may be roughened such that the center-line average roughness Ra of the surface of the conductive support is 0.04 μm or more and 0.5 μm or less in order to reduce interference fringes formed when the photosensitive member is irradiated with a laser beam. On the other hand, it is not necessary to roughen the surface of the conductive support in order to reduce the formation of interference fringes in the case where an incoherent light source is used. However, roughening the surface of the conductive support may increase the service life of the photosensitive member by reducing the occurrence of defects caused due to the irregularities formed in the surface of the conductive support.

For roughening the surface of the conductive support, for example, the following methods may be employed: wet honing in which a suspension prepared by suspending abrasive particles in water is blown onto the surface of the conductive support; centerless grinding in which the conductive support is continuously ground with rotating grinding wheels brought into pressure contact with the conductive support; and an anodic oxidation treatment.

Another example of the roughening method is a method in which, instead of roughening the surface of the conductive support, a layer is formed on the surface of the conductive support by using a resin including conductive or semiconductive powder particles dispersed therein such that a rough surface is formed due to the particles dispersed in the layer.

In a roughening treatment using anodic oxidation, an oxidation film is formed on the surface of a conductive support made of a metal, such as aluminum, by performing anodic oxidation using the conductive support as an anode in an electrolyte solution. Examples of the electrolyte solution include a sulfuric acid solution and an oxalic acid solution. A porous anodic oxidation film formed by anodic oxidation is originally chemically active and likely to become contaminated. In addition, the resistance of the porous anodic oxidation film is likely to vary widely with the environment. Accordingly, the porous anodic oxidation film may be subjected to a pore-sealing treatment in which micropores formed in the oxide film are sealed using volume expansion caused by a hydration reaction of the oxidation film in steam under pressure or in boiled water that may include a salt of a metal, such as nickel, so as to be converted into a more stable hydrous oxide film.

The thickness of the anodic oxidation film may be, for example, 0.3 μm or more and 15 μm or less. When the thickness of the anodic oxidation film falls within the above range, the anodic oxidation film may serve as a barrier to injection. Furthermore, an increase in the potential that remains on the photosensitive member after the repeated use of the photosensitive member may be limited.

The conductive support may be subjected to a treatment in which an acidic treatment liquid is used or a boehmite treatment.

The treatment in which an acidic treatment liquid is used is performed in, for example, the following manner. An acidic treatment liquid that includes phosphoric acid, chromium acid, and hydrofluoric acid is prepared. The proportions of the phosphoric acid, chromium acid, and hydrofluoric acid in the acidic treatment liquid may be, for example, 10% by mass or more and 11% by mass or less, 3% by mass or more and 5% by mass or less, and 0.5% by mass or more and 2% by mass or less, respectively. The total concentration of the above acids may be 13.5% by mass or more and 18% by mass or less. The treatment temperature may be, for example, 42° C. or more and 48° C. or less. The thickness of the resulting coating film may be 0.3 μm or more and 15 μm or less.

In the boehmite treatment, for example, the conductive support is immersed in pure water having a temperature of 90° C. or more and 100° C. or less for 5 to 60 minutes or brought into contact with steam having a temperature of 90° C. or more and 120° C. or less for 5 to 60 minutes. The thickness of the resulting coating film may be 0.1 μm or more and 5 μm or less. The coating film may optionally be subjected to an anodic oxidation treatment with an electrolyte solution in which the coating film is hardly soluble, such as adipic acid, boric acid, a boric acid salt, a phosphoric acid salt, a phthalic acid salt, a maleic acid salt, a benzoic acid salt, a tartaric acid salt, or a citric acid salt.

### Undercoat Layer

The undercoat layer is a layer that includes, for example, inorganic particles and a binder resin.

The inorganic particles may have, for example, a powder resistivity (i.e., volume resistivity) of 10² Ωcm or more and 10¹¹ Ωcm or less.

Among such inorganic particles having the above resistivity, for example, metal oxide particles such as tin oxide particles, titanium oxide particles, zinc oxide particles, and zirconium oxide particles are preferable and zinc oxide particles are particularly preferable.

The BET specific surface area of the inorganic particles may be, for example, 10 m²/g or more.

The volume average diameter of the inorganic particles may be, for example, 50 nm or more and 2,000 nm or less and is preferably 60 nm or more and 1,000 nm or less.

The content of the inorganic particles is preferably, for example, 10% by mass or more and 80% by mass or less and is more preferably 40% by mass or more and 80% by mass or less of the amount of binder resin.

The inorganic particles may optionally be subjected to a surface treatment. It is possible to use two or more types of inorganic particles which have been subjected to different surface treatments or have different diameters in a mixture.

Examples of an agent used in the surface treatment include a silane coupling agent, a titanate coupling agent, an aluminum coupling agent, and a surfactant. In particular, a silane coupling agent is preferable, and a silane coupling agent including an amino group is more preferable.

Examples of the silane coupling agent including an amino group include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be used in a mixture. For example, a silane coupling agent including an amino group may be used in combination with another type of silane coupling agent. Examples of the other type of silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

A method for treating the surface of the inorganic particles with the surface treating agent is not limited, and any known surface treatment method may be employed. Either dry process or wet process may be employed.

The amount of surface treating agent used may be, for example, 0.5% by mass or more and 10% by mass or less of the amount of inorganic particles.

The undercoat layer may include an electron accepting compound (i.e., an acceptor compound) in addition to the inorganic particles in order to enhance the long-term stability of electrical properties and carrier-blocking property.

Examples of the electron accepting compound include the following electron transporting substances: quinone compounds, such as chloranil and bromanil; tetracyanoquinodimethane compounds; fluorenone compounds, such as 2,4,7-trinitrofluorenone and 2,4,5,7-tetranitro-9-fluorenone; oxadiazole compounds, such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone compounds; thiophene compounds; and diphenoquinone compounds, such as 3,3′,5,5′-tetra-t-butyldiphenoquinone.

In particular, compounds including an anthraquinone structure may be used as an electron accepting compound. Examples of the compounds including an anthraquinone structure include hydroxyanthraquinone compounds, aminoanthraquinone compounds, and aminohydroxyanthraquinone compounds. Specific examples thereof include anthraquinone, alizarin, quinizarin, anthrarufin, and purpurin.

The electron accepting compound may be dispersed in the undercoat layer together with the inorganic particles or deposited on the surfaces of the inorganic particles.

For attaching the electron accepting compound onto the surfaces of the inorganic particles, for example, a dry process or a wet process may be employed.

In a dry process, for example, while the inorganic particles are stirred with a mixer or the like capable of producing a large shearing force, the electron accepting compound or a solution prepared by dissolving the electron accepting compound in an organic solvent is added dropwise or sprayed together with dry air or a nitrogen gas to the inorganic particles in order to deposit the electron accepting compound on the surfaces of the inorganic particles. The addition or spraying of the electron accepting compound may be done at a temperature equal to or lower than the boiling point of the solvent used. Subsequent to the addition or spraying of the electron accepting compound, the resulting inorganic particles may optionally be baked at 100° C. or more. The temperature at which the inorganic particles are baked and the amount of time during which the inorganic particles are baked are not limited; the inorganic particles may be baked under appropriate conditions of temperature and time under which the intended electrophotographic properties are achieved.

In a wet process, for example, while the inorganic particles are dispersed in a solvent with a stirrer, an ultrasonic wave, a sand mill, an Attritor, a ball mill, or the like, the electron accepting compound is added to the dispersion liquid. After the resulting mixture has been stirred or dispersed, the solvent is removed such that the electron accepting compound is deposited on the surfaces of the inorganic particles. The removal of the solvent may be done by, for example, filtration or distillation. Subsequent to the removal of the solvent, the resulting inorganic particles may optionally be baked at 100° C. or more. The temperature at which the inorganic particles are baked and the amount of time during which the inorganic particles are baked are not limited; the inorganic particles may be baked under appropriate conditions of temperature and time under which the intended electrophotographic properties are achieved. In the wet process, moisture contained in the inorganic particles may be removed prior to the addition of the electron accepting compound. The removal of moisture contained in the inorganic particles may be done by, for example, heating the inorganic particles while being stirred in the solvent or by bringing the moisture to the boil together with the solvent.

The deposition of the electron accepting compound may be done prior or subsequent to the surface treatment of the inorganic particles with the surface treating agent. Alternatively, the deposition of the electron accepting compound and the surface treatment using the surface treating agent may be performed at the same time.

The content of the electron accepting compound may be, for example, 0.01% by mass or more and 20% by mass or less and is preferably 0.01% by mass or more and 10% by mass or less of the amount of inorganic particles.

Examples of the binder resin included in the undercoat layer include the following known materials: known high-molecular compounds such as an acetal resin (e.g., polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenolic resin, a phenol-formaldehyde resin, a melamine resin, a urethane resin, an alkyd resin, and an epoxy resin; zirconium chelate compounds; titanium chelate compounds; aluminum chelate compounds; titanium alkoxide compounds; organotitanium compounds; and silane coupling agents.

Other examples of the binder resin included in the undercoat layer include charge transporting resins including a charge transporting group and conductive resins such as polyaniline.

Among the above binder resins, a resin insoluble in a solvent included in a coating liquid used for forming a layer on the undercoat layer may be used as a binder resin included in the undercoat layer. In particular, resins produced by reacting at least one resin selected from the group consisting of thermosetting resins (e.g., a urea resin, a phenolic resin, a phenol-formaldehyde resin, a melamine resin, a urethane resin, an unsaturated polyester resin, an alkyd resin, and an epoxy resin), polyamide resins, polyester resins, polyether resins, methacrylic resins, acrylic resins, polyvinyl alcohol resins, and polyvinyl acetal resins with a curing agent may be used.

In the case where two or more types of the above binder resins are used in combination, the mixing ratio may be set appropriately.

The undercoat layer may include various additives in order to enhance electrical properties, environmental stability, and image quality.

Examples of the additives include the following known materials: electron transporting pigments such as polycondensed pigments and azo pigments, zirconium chelate compounds, titanium chelate compounds, aluminum chelate compounds, titanium alkoxide compounds, organotitanium compounds, and silane coupling agents. The silane coupling agents, which are used in the surface treatment of the inorganic particles as described above, may also be added to the undercoat layer as an additive.

Examples of silane coupling agents that may be used as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compounds include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compounds include tetraisopropyl titanate, tetra-n-butyl titanate, butyl titanate dimer, tetra-(2-ethylhexyl) titanate, titanium acetylacetonate, polytitanium acetylacetonate, titanium octylene glycolate, titanium lactate ammonium salt, titanium lactate, titanium lactate ethyl ester, titanium triethanolaminate, and polyhydroxy titanium stearate.

Examples of the aluminum chelate compounds include aluminum isopropylate, monobutoxy aluminum diisopropylate, aluminum butyrate, diethyl acetoacetate aluminum diisopropylate, and aluminum tris(ethyl acetoacetate).

The above additives may be used alone. Alternatively, two or more types of the above additives may be used in a mixture or in the form of a polycondensate.

The undercoat layer may have a Vickers hardness of 35 or more.

In order to reduce the formation of moiré fringes, the surface roughness (i.e., ten-point average roughness) of the undercoat layer may be adjusted to 1/(4n) to ½ of the wavelength λ of the laser beam used as exposure light, where n is the refractive index of the layer that is to be formed on the undercoat layer.

Resin particles and the like may be added to the undercoat layer in order to adjust the surface roughness of the undercoat layer. Examples of the resin particles include silicone resin particles and crosslinked polymethyl methacrylate resin particles. The surface of the undercoat layer may be ground in order to adjust the surface roughness of the undercoat layer. For grinding the surface of the undercoat layer, buffing, sand blasting, wet honing, grinding, and the like may be performed.

The method for forming the undercoat layer is not limited, and known methods may be employed. The undercoat layer may be formed by, for example, forming a coating film using a coating liquid prepared by mixing the above-described components with a solvent (hereinafter, this coating liquid is referred to as “undercoat layer-forming coating liquid”), drying the coating film, and, as needed, heating the coating film.

Examples of the solvent used for preparing the undercoat layer-forming coating liquid include known organic solvents, such as an alcohol solvent, an aromatic hydrocarbon solvent, a halogenated hydrocarbon solvent, a ketone solvent, a ketone alcohol solvent, an ether solvent, and an ester solvent.

Specific examples thereof include the following common organic solvents: methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

For dispersing the inorganic particles in the preparation of the undercoat layer-forming coating liquid, for example, known equipment such as a roll mill, a ball mill, a vibrating ball mill, an Attritor, a sand mill, a colloid mill, and a paint shaker may be used.

For coating the conductive support with the undercoat layer-forming coating liquid, for example, common methods such as blade coating, wire bar coating, spray coating, dip coating, bead coating, air knife coating, and curtain coating may be employed.

The thickness of the undercoat layer is preferably, for example, 15 μm or more and is more preferably 20 μm or more and 50 μm or less.

### Intermediate Layer

Although not illustrated in the drawings, an intermediate layer may optionally be interposed between the undercoat layer and the photosensitive layer.

The intermediate layer includes, for example, a resin. Examples of the resin included in the intermediate layer include the following high-molecular compounds: acetal resins (e.g., polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may include an organometallic compound. Examples of the organometallic compound included in the intermediate layer include organometallic compounds containing a metal atom such as a zirconium atom, a titanium atom, an aluminum atom, a manganese atom, or a silicon atom.

The above compounds included in the intermediate layer may be used alone. Alternatively, two or more types of the above compounds may be used in a mixture or in the form of a polycondensate.

In particular, the intermediate layer may include an organometallic compound containing a zirconium atom or a silicon atom.

The method for forming the intermediate layer is not limited, and known methods may be employed. The intermediate layer may be formed by, for example, forming a coating film using an intermediate layer-forming coating liquid prepared by mixing the above-described components with a solvent, drying the coating film, and, as needed, heating the coating film.

For forming the intermediate layer, common coating methods such as dip coating, push coating, wire bar coating, spray coating, blade coating, knife coating, and curtain coating may be employed.

The thickness of the intermediate layer may be, for example, 0.1 μm or more and 3 μm or less. It is possible to use the intermediate layer also as an undercoat layer.

### Charge Generation Layer

The charge generation layer is, for example, a layer that includes a charge generating material and a binder resin. The charge generation layer may be a layer formed by vapor deposition of a charge generating material. The vapor deposition layer of a charge generating material may be used in the case where an incoherent light source, such as a light emitting diode (LED) or an organic electro-luminescence (EL) image array, is used.

Examples of the charge generating material include azo pigments, such as bisazo and trisazo; condensed aromatic pigments, such as dibromoanthanthrone; perylene pigments; pyrrolopyrrole pigments; phthalocyanine pigments; zinc oxide; and trigonal selenium.

Among the above charge generating materials, in particular, a metal phthalocyanine pigment or a nonmetal phthalocyanine pigment may be used in consideration of exposure to a laser beam in the near-infrared region. Specific examples of such charge generating materials include hydroxygallium phthalocyanine, chlorogallium phthalocyanine, dichloro tin phthalocyanine, and titanyl phthalocyanine.

Among the above charge generating materials, condensed aromatic pigments such as dibromoanthanthrone; thioindigo pigments; porphyrazine compounds; zinc oxide; trigonal selenium; and bisazo pigments may be used in consideration of exposure to a laser beam in the near-ultraviolet region.

The above charge generating materials may be used also in the case where an incoherent light source such as an LED or an organic EL image array, which emits light having a center wavelength of 450 nm or more and 780 nm or less, is used. However, when the thickness of the photosensitive layer is reduced to 20 μm or less in order to increase the resolution, the strength of the electric field in the photosensitive layer may be increased. This increases the occurrence of a reduction in the amount of charge generated due to the injection of charge from the substrate, that is, image defects referred to as “black spots”. This becomes more pronounced when a p-type semiconductor that is likely to induce a dark current, such as trigonal selenium or a phthalocyanine pigment, is used as a charge generating material.

In contrast, in the case where an n-type semiconductor such as a condensed aromatic pigment, a perylene pigment, or an azo pigment is used as a charge generating material, the dark current is hardly induced and the occurrence of the image defects referred to as “black spots”, may be reduced even when the thickness of the photosensitive layer is reduced.

Whether or not a charge generating material is n-type is determined on the basis of the polarity of the photoelectric current that flows in the charge generating material by a commonly used time-of-flight method. Specifically, a charge generating material in which electrons are more easily transmitted as carriers than holes is determined to be n-type.

The binder resin included in the charge generation layer is selected from various insulating resins. The binder resin may also be selected from organic photoconductive polymers such as poly-N-vinylcarbazole, polyvinyl anthracene, polyvinylpyrene, and polysilane.

Specific examples of the binder resin include a polyvinyl butyral resin, a polyarylate resin (e.g., polycondensate of a bisphenol and an aromatic dicarboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. The term “insulating” used herein refers to having a volume resistivity of 10¹³ Ωcm or more.

The above binder resins may be used alone or in a mixture of two or more.

The ratio of the amount of charge generating material to the amount of binder resin may be 10:1 to 1:10 by mass.

The charge generation layer may optionally include the additives known in the related art.

The method for forming the charge generation layer is not limited. Any known method may be employed. The charge generation layer may be formed by, for example, forming a coating film using a coating liquid prepared by mixing the above-described components with a solvent (hereinafter, this coating liquid is referred to as “charge generation layer-forming coating liquid”), drying the coating film, and, as needed, heating the coating film. Alternatively, the charge generation layer may be formed by the vapor deposition of the charge generating material. The charge generation layer may be formed by the vapor deposition particularly when the charge generating material is a condensed aromatic pigment or a perylene pigment.

Examples of the solvent used for preparing the charge generation layer-forming coating liquid include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The above solvents may be used alone or in a mixture of two or more.

For dispersing particles of the charge generating material or the like in the charge generation layer-forming coating liquid, for example, media dispersing machines, such as a ball mill, a vibrating ball mill, an Attritor, a sand mill, and a horizontal sand mill; and medialess dispersing machines, such as a stirrer, an ultrasonic wave disperser, a roll mill, and a high-pressure homogenizer, may be used. Specific examples of the high-pressure homogenizer include an impact-type homogenizer in which a dispersion liquid is brought into collision with a liquid or a wall under a high pressure in order to perform dispersion and a through-type homogenizer in which a dispersion liquid is passed through a very thin channel under a high pressure in order to perform dispersion.

It is effective that the average diameter of the particles of the charge generating material dispersed in the charge generation layer-forming coating liquid be 0.5 μm or less, be preferably 0.3 μm or less, and be further preferably 0.15 μm or less.

For applying the charge generation layer-forming coating liquid to the undercoat layer (or, the intermediate layer), for example, common coating methods, such as blade coating, wire bar coating, spray coating, dip coating, bead coating, air knife coating, and curtain coating, may be employed.

The thickness of the charge generation layer is, for example, preferably 0.1 μm or more and 5.0 μm or less and is more preferably 0.2 μm or more and 2.0 μm or less.

### Charge Transport Layer

The charge transport layer is a layer including a charge transporting material, a binder resin, and the like. The charge transport layer may be a layer including a high-molecular charge transporting material.

Examples of the charge transporting material include, but are not limited to, the following electron transporting compounds: quinone compounds, such as p-benzoquinone, chloranil, bromanil, and anthraquinone; tetracyanoquinodimethane compounds; fluorenone compounds, such as 2,4,7-trinitrofluorenone; xanthone compounds; benzophenone compounds; cyanovinyl compounds; and ethylene compounds. Examples of the charge transporting material further include hole transporting compounds, such as triarylamine compounds, benzidine compounds, arylalkane compounds, aryl-substituted ethylene compounds, stilbene compounds, anthracene compounds, and hydrazone compounds. The above charge transporting materials may be used alone or in combination of two or more.

In particular, the triarylamine derivative represented by Structural Formula (a-1) below or the benzidine derivative represented by Structural Formula (a-2) below may be used as a charge transporting material in consideration of the mobility of charge.

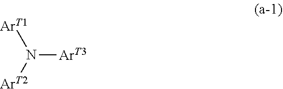

In Structural Formula (a-1), Ar^{T1}, Ar^{T2}, and Ar^{T3} each independently represent an aryl group, a substituted aryl group, a —C₆H₄—C(R^{T4})═C(R^{T5})(R^{T6}) group, or a —C₆H₄—CH═CH—CH═C(R^{T7})(R^{T8}) group, where R^{T4}, R^{T5}, R^{T6}, R^{T7}, and R^{T8} each independently represent a hydrogen atom, an alkyl group, a substituted alkyl group, an aryl group, or a substituted aryl group.

Examples of a substituent included in the above substituted groups include a halogen atom, an alkyl group having 1 to 5 carbon atoms, an alkoxy group having 1 to 5 carbon atoms, and an amino group substituted with an alkyl group having 1 to 3 carbon atoms.

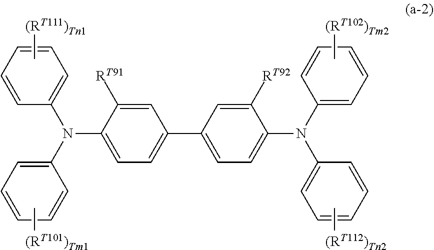

In Structural Formula (a-2), R^{T91} and R^{T92} each independently represent a hydrogen atom, a halogen atom, an alkyl group having 1 to 5 carbon atoms, or an alkoxy group having 1 to 5 carbon atoms; R^{T101}, R^{T102}, R^{T111}, and R^{T112} each independently represent a halogen atom, an alkyl group having 1 to 5 carbon atoms, an alkoxy group having 1 to 5 carbon atoms, an amino group substituted with an alkyl group having 1 or 2 carbon atoms, an aryl group, a substituted aryl group, a —C(R^{T12})═C(R^{T13})(R^{T14}) group, or a —CH═CH—CH═C(R^{T15}) (R^{T16}) group, where R^{T12}, R^{T13}, R^{T14}, R^{T15}, and R^{T16} each independently represent a hydrogen atom, an alkyl group, a substituted alkyl group, an aryl group, or a substituted aryl group; and Tm1, Tm2, Tn1, and Tn2 each independently represent an integer of 0 to 2.

Examples of a substituent included in the above substituted groups include a halogen atom, an alkyl group having 1 to 5 carbon atoms, an alkoxy group having 1 to 5 carbon atoms, and an amino group substituted with an alkyl group having 1 to 3 carbon atoms.

Among triarylamine derivatives represented by Structural Formula (a-1) above and benzidine derivatives represented by Structural Formula (a-2) above, in particular, a triarylamine derivative that includes the —C₆H₄—CH═CH—CH═C(R^{T7})(R^{T8}) group or a benzidine derivative that includes the —CH═CH—CH═C(R^{T15})(R^{T16}) group may be used in consideration of the mobility of charge.

The high-molecular charge transporting material may be any known charge transporting material, such as poly-N-vinylcarbazole or polysilane. In particular, a polyester high-molecular charge transporting material may be used. The above high-molecular charge transporting materials may be used alone or in combination with the above binder resins.

Examples of the binder resin included in the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among the above binder resins, in particular, a polycarbonate resin and a polyarylate resin may be used. The above binder resins are used alone or in combination of two or more.

The ratio of the amounts of the charge transporting material and the binder resin included in the charge transport layer may be 10:1 to 1:5 by mass.

The charge transport layer may optionally include known additives.

The method for forming the charge transport layer is not limited, and any known method may be employed. The charge transport layer may be formed by, for example, forming a coating film using a coating liquid prepared by mixing the above-described components with a solvent (hereinafter, this coating liquid is referred to as “charge transport layer-forming coating liquid”), drying the coating film, and, as needed, heating the coating film.

Examples of the solvent used for preparing the charge transport layer-forming coating liquid include the following common organic solvents: aromatic hydrocarbons, such as benzene, toluene, xylene, and chlorobenzene; ketones, such as acetone and 2-butanone; halogenated aliphatic hydrocarbons, such as methylene chloride, chloroform, and ethylene chloride; and cyclic and linear ethers, such as tetrahydrofuran and ethyl ether. The above solvents may be used alone or in a mixture of two or more.

For applying the charge transport layer-forming coating liquid onto the surface of the charge generation layer, for example, the following common coating methods may be used: blade coating, wire bar coating, spray coating, dip coating, bead coating, air knife coating, and curtain coating.

The thickness of the charge transport layer is, for example, preferably 5 μm or more and 50 μm or less and is more preferably 10 μm or more and 30 μm or less.

### Single-Layer Photosensitive Layer

A single-layer photosensitive layer (i.e., charge generation and transport layer) includes, for example, a charge generating material, a charge transporting material, and, as needed, a binder resin and known additives. The above materials are the same as those described in Charge Generation Layer and Charge Transport Layer above.

The content of the charge generating material in the single-layer photosensitive layer is preferably 0.1% by mass or more and 10% by mass or less and is more preferably 0.8% by mass or more and 5% by mass or less of the total solid content of the single-layer photosensitive layer. The content of the charge transporting material in the single-layer photosensitive layer may be 5% by mass or more and 50% by mass or less of the total solid content of the single-layer photosensitive layer.

The single-layer photosensitive layer may be formed by the same method as in the formation of the charge generation layer and the charge transport layer.

The thickness of the single-layer photosensitive layer is, for example, preferably 5 μm or more and 50 μm or less and is more preferably 10 μm or more and 40 μm or less.

### Image Forming Apparatus and Process Cartridge

An image forming apparatus according to this exemplary embodiment includes an electrophotographic photosensitive member; a charging unit that charges the surface of the electrophotographic photosensitive member; a unit that forms an electrostatic latent image on the charged surface of the electrophotographic photosensitive member (hereinafter, this unit is referred to as “electrostatic latent image forming unit”); a developing unit that develops the electrostatic latent image formed on the surface of the electrophotographic photosensitive member with a developer including a toner in order to form a toner image; and a transfer unit that transfers the toner image onto the surface of a recording medium. The electrophotographic photosensitive member is the electrophotographic photosensitive member according to the above-described exemplary embodiment.

The image forming apparatus according to this exemplary embodiment may be implemented as any of the following known image forming apparatuses: an image forming apparatus that includes a fixing unit that fixes the toner image transferred on the surface of the recording medium; a direct-transfer image forming apparatus that directly transfers a toner image formed on the surface of the electrophotographic photosensitive member onto the surface of a recording medium; an intermediate-transfer image forming apparatus that transfers a toner image formed on the surface of the electrophotographic photosensitive member onto the surface of an intermediate transfer body (this process is referred to as “first transfer”) and further transfers the toner image transferred on the surface of the intermediate transfer body onto the surface of a recording medium (this process is referred to as “second transfer”); an image forming apparatus that includes a cleaning unit that cleans the surface of the electrophotographic photosensitive member after the toner image has been transferred and before the electrophotographic photosensitive member is charged; an image forming apparatus that includes an erasing unit that irradiates, with erasing light, the surface of the electrophotographic photosensitive member after the toner image has been transferred and before the electrophotographic photosensitive member is charged in order to erase charge; and an image forming apparatus that includes an electrophotographic photosensitive member heating member that heats the electrophotographic photosensitive member in order to lower the relative temperature.

In the intermediate-transfer image forming apparatus, the transfer unit includes, for example, an intermediate transfer body onto which a toner image is transferred, a first transfer unit that transfers a toner image formed on the surface of the electrophotographic photosensitive member onto the surface of the intermediate transfer body (first transfer), and a second transfer unit that transfers the toner image transferred on the surface of the intermediate transfer body onto the surface of a recording medium (second transfer).

The image forming apparatus according to this exemplary embodiment may be either a dry-developing image forming apparatus or a wet-developing image forming apparatus in which a liquid developer is used for developing images.

In the image forming apparatus according to this exemplary embodiment, for example, a portion including the electrophotographic photosensitive member may have a cartridge structure, that is, may be a process cartridge, which is detachably attachable to the image forming apparatus. The process cartridge may include, for example, the electrophotographic photosensitive member according to the above-described exemplary embodiment. The process cartridge may further include, for example, at least one component selected from the group consisting of the charging unit, the electrostatic latent image forming unit, the developing unit, and the transfer unit.

An example of the image forming apparatus according to this exemplary embodiment is described below. However, the image forming apparatus is not limited to this. Hereinafter, only the components illustrated in the drawings are described, and the descriptions of the other components are omitted.

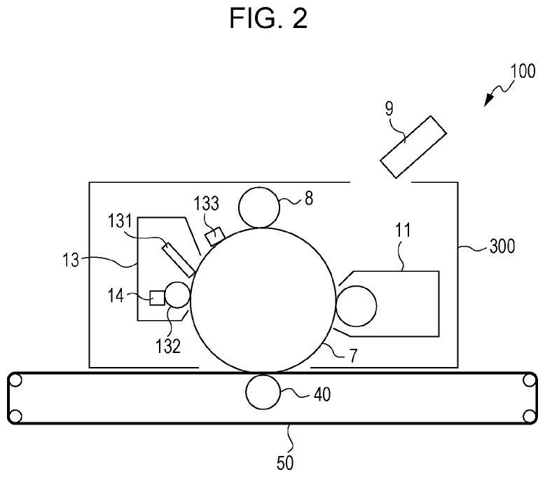

FIG. 2 schematically illustrates an example of the image forming apparatus according to this exemplary embodiment.

As illustrated in FIG. 2, an image forming apparatus 100 according to this exemplary embodiment includes a process cartridge 300 including an electrophotographic photosensitive member 7, an exposure device 9 (an example of the electrostatic latent image forming unit), a transfer device 40 (i.e., a first transfer device), and an intermediate transfer body 50. In the image forming apparatus 100, the exposure device 9 is arranged such that the electrophotographic photosensitive member 7 is exposed to light emitted by the exposure device 9 through an aperture formed in the process cartridge 300; the transfer device 40 is arranged to face the electrophotographic photosensitive member 7 across the intermediate transfer body 50; and the intermediate transfer body 50 is arranged such that a part of the intermediate transfer body 50 comes into contact with the electrophotographic photosensitive member 7. Although not illustrated in FIG. 2, the image forming apparatus 100 also includes a second transfer device that transfers a toner image transferred on the intermediate transfer body 50 onto a recording medium, such as paper. The intermediate transfer body 50, the transfer device 40 (i.e., a first transfer device), and the second transfer device (not illustrated) correspond to an example of the transfer unit.

The process cartridge 300 illustrated in FIG. 2 includes the electrophotographic photosensitive member 7, a charging device 8 (an example of the charging unit), a developing device 11 (an example of the developing unit), and a cleaning device 13 (an example of the cleaning unit), which are integrally supported inside a housing. The cleaning device 13 includes a cleaning blade 131 (an example of the cleaning member), which is arranged to come into contact with the surface of the electrophotographic photosensitive member 7. The cleaning member is not limited to the cleaning blade 131 and may be a conductive or insulative fibrous member. The conductive or insulative fibrous member may be used alone or in combination with the cleaning blade 131.

The image forming apparatus illustrated in FIG. 2 includes a roller-like, fibrous member 132 with which a lubricant 14 is fed onto the surface of the electrophotographic photosensitive member 7 and a flat-brush-like, fibrous member 133 that assists cleaning. However, the image forming apparatus illustrated in FIG. 2 is merely an example, and the fibrous members 132 and 133 are optional.

The components of the image forming apparatus according to this exemplary embodiment are described below.

### Charging Device

Examples of the charging device 8 include contact chargers that include a charging roller, a charging brush, a charging film, a charging rubber blade, or a charging tube that are conductive or semiconductive; contactless roller chargers; and known chargers such as a scorotron charger and a corotron charger that use corona discharge.

### Exposure Device

The exposure device 9 may be, for example, an optical device with which the surface of the electrophotographic photosensitive member 7 can be exposed to light emitted by a semiconductor laser, an LED, a liquid-crystal shutter, or the like in a predetermined image pattern. The wavelength of the light source is set to fall within the range of the spectral sensitivity of the electrophotographic photosensitive member. Although common semiconductor lasers have an oscillation wavelength in the vicinity of 780 nm, that is, the near-infrared region, the wavelength of the light source is not limited to this; lasers having an oscillation wavelength of about 600 to 700 nm and blue lasers having an oscillation wavelength of 400 nm or more and 450 nm or less may also be used. For forming color images, surface-emitting lasers capable of emitting multi beam may be used as a light source.

### Developing Device

The developing device 11 may be, for example, a common developing device that develops latent images with a developer in a contacting or noncontacting manner. The developing device 11 is not limited and may be selected from developing devices having the above functions in accordance with the purpose. Examples of the developing device include known developing devices capable of depositing a one- or two-component developer on the electrophotographic photosensitive member 7 with a brush, a roller, or the like. In particular, a developing device including a developing roller on which a developer is deposited may be used.

The developer included in the developing device 11 may be either a one-component developer including only a toner or a two-component developer including a toner and a carrier. The developer may be magnetic or nonmagnetic. Known developers may be used as a developer included in the developing device 11.

### Cleaning Device

The cleaning device 13 is a cleaning-blade-type cleaning device including a cleaning blade 131.

The cleaning device 13 is not limited to a cleaning-blade-type cleaning device and may be a fur-brush-cleaning-type cleaning device or a cleaning device that performs cleaning during development.

### Transfer Device

Examples of the transfer device 40 include contact transfer chargers including a belt, a roller, a film, a rubber blade, or the like; and known transfer chargers which use corona discharge, such as a scorotron transfer charger and a corotron transfer charger.

### Intermediate Transfer Body

The intermediate transfer body 50 is a belt-like intermediate transfer body, that is, an intermediate transfer belt, including polyimide, polyamideimide, polycarbonate, polyarylate, polyester, a rubber, or the like that is made semiconductive. The intermediate transfer body is not limited to a belt-like intermediate transfer body and may be a drum-like intermediate transfer body.

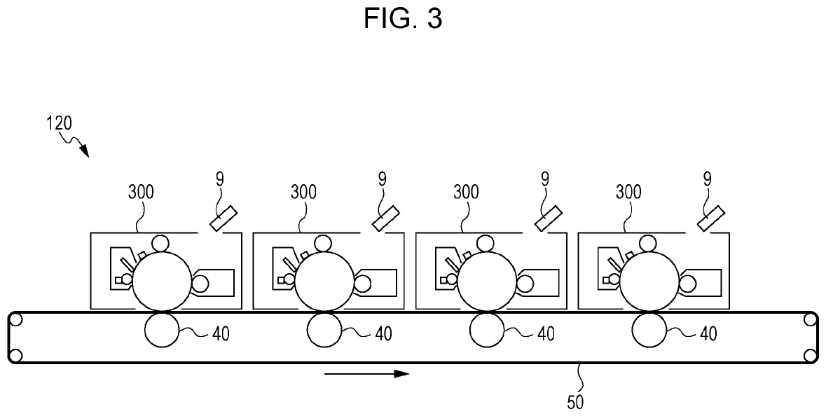

FIG. 3 schematically illustrates another example of the image forming apparatus according to this exemplary embodiment.

The image forming apparatus 120 illustrated in FIG. 3 is a tandem, multi-color image forming apparatus including four process cartridges 300. In the image forming apparatus 120, the four process cartridges 300 are arranged in parallel to one another on an intermediate transfer body 50, and one electrophotographic photosensitive member is used for one color. The image forming apparatus 120 has the same structure as the image forming apparatus 100 except that the image forming apparatus 120 is tandem.

### Examples

The electrophotographic photosensitive member according to an exemplary embodiment of the present disclosure is described further specifically with reference to Examples below. The materials described in Examples below, the amounts of the materials used, the proportions of the materials, treatment procedure, and the like can be modified appropriately without departing from the scope of the present disclosure. Thus, the scope of the electrophotographic photosensitive member according to the present disclosure should not be interpreted to be limited by the following specific examples.

### Preparation of Electrophotographic Photosensitive Member

### Example 1

Formation of Undercoat Layer

With 100 parts by mass of zinc oxide (average particle size: 70 nm, specific surface area: 15 m²/g) produced by Tayca Corporation, 500 parts by mass of toluene is mixed while stirring is performed. To the resulting mixture, 1.3 parts by mass of a silane coupling agent “KBM503” produced by Shin-Etsu Chemical Co., Ltd. is added. The resulting mixture is stirred for 2 hours. Subsequently, toluene is removed by reduced-pressure distillation. Then, burning is performed at 120° C. for 3 hours. Hereby, zinc oxide particles surface-treated with a silane coupling agent are prepared. With 110 parts by mass of the surface-treated zinc oxide particles, 500 parts by mass of tetrahydrofuran is mixed while stirring is performed. To the resulting mixture, a solution prepared by dissolving 0.6 parts by mass of alizarin in 50 parts by mass of tetrahydrofuran is added. The mixture is stirred at 50° C. for 5 hours. Subsequently, zinc oxide particles on which alizarin is deposited are separated by filtration under reduced pressure. Furthermore, drying is performed at 60° C. under reduced pressure. Hereby, zinc oxide particles on which alizarin is deposited are prepared.

With 38 parts by mass of a liquid mixture prepared by mixing 60 parts by mass of the zinc oxide particles on which alizarin is deposited, 13.5 parts by mass of a curing agent that is a blocked isocyanate “SUMIDUR 3175” produced by Sumitomo Bayer Urethane Co., Ltd., and 15 parts by mass of a butyral resin “S-LEC BM-1” produced by Sekisui Chemical Co., Ltd. with 85 parts by mass of methyl ethyl ketone, 25 parts by mass of methyl ethyl ketone is mixed. The resulting mixture is dispersed for 2 hours using a sand mill with glass beads having a diameter of 1 mm to form a dispersion liquid. To the dispersion liquid, 0.005 parts by mass of dioctyltin dilaurate used as a catalyst and 40 parts by mass of silicone resin particles “TOSPEARL 145” produced by Momentive Performance Materials Inc. are added. Hereby, an undercoat layer-forming coating liquid is prepared. The undercoat layer-forming coating liquid is applied to an aluminum conductive support having a thickness described in Table 1 by dip coating. The resulting coating film is dried to cure at 170° C. for 40 minutes to form an undercoat layer having a thickness of 20 μm.

Formation of Charge Generation Layer

Hydroxygallium phthalocyanine used as a charge generating material which has diffraction peaks at Bragg angles (20±0.2°) of at least 7.5°, 16.3°, 25.0°, and 28.3° in a X-ray diffraction spectrum prepared using Cuka X-ray is prepared. A mixture of 15 parts by mass of the hydroxygallium phthalocyanine, 10 parts by mass of a vinyl chloride-vinyl acetate copolymer resin “VMCH” produced by Nippon Unicar Company Limited, and 200 parts by mass of n-butyl acetate is dispersed for 4 hours using a sand mill with glass beads having a diameter of 1 mm. To the resulting dispersion liquid, 175 parts by mass of n-butyl acetate and 180 parts by mass of methyl ethyl ketone are added. The resulting mixture is stirred to form a charge generation layer-forming coating liquid. This coating liquid is applied to the undercoat layer by dip coating. The resulting coating film is dried at 150° C. for 10 minutes to form a charge generation layer having a thickness of 0.2 μm.

Formation of Charge Transport Layer

In 800 parts by mass of tetrahydrofuran, 38 parts by mass of the charge transporting material (HT-1), 10 parts by mass of the charge transporting material (HT-2), and 52 parts by mass of the polycarbonate (A) (viscosity average molecular weight: 48,000) are dissolved. Hereby, a charge transport layer-forming coating liquid is prepared. This coating liquid is applied to the charge generation layer by dip coating. The resulting coating film is dried at 140° C. for 40 minutes to form a charge transport layer having a thickness of 26 μm.

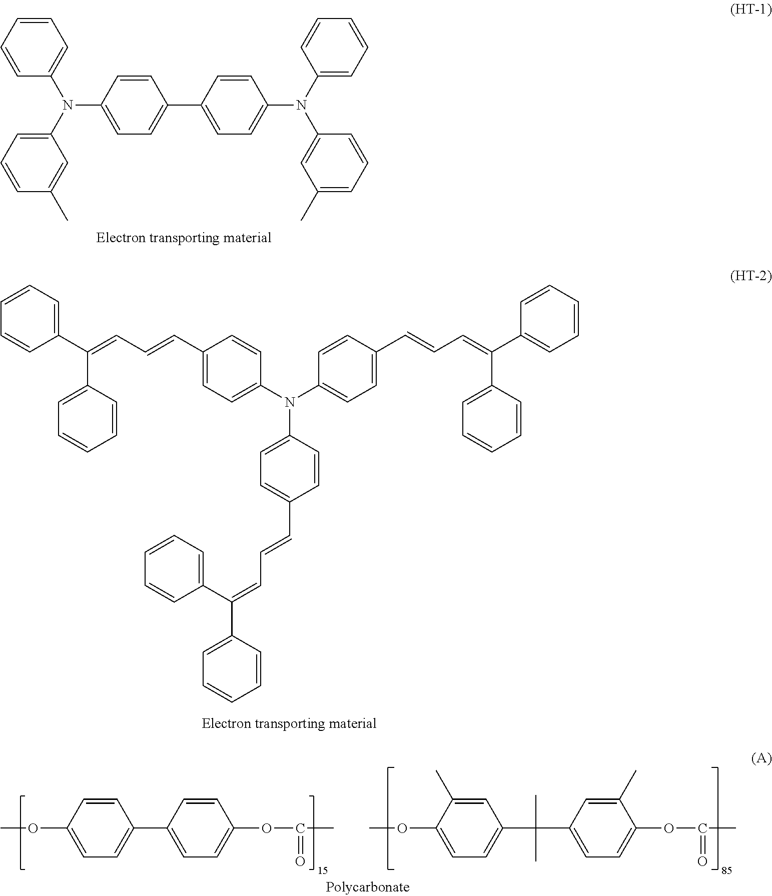

Formation of Surface Protection Layer A surface protection layer composed of a film formed by heat-curing a composition including a reactive group-containing charge transporting material that includes a reactive group and a charge transporting skeleton in the same molecule is formed in the following manner.

To 220 parts by mass of 2-propanol, 70 parts by mass of a compound (2) represented by the structural formula below, which is a reactive group-containing charge transporting material, 15 parts by mass of a compound (3) represented by the structural formula below, which is a reactive group-containing charge transporting material, and 4.4 parts by mass of a curable resin that serves as a reactive group-containing non-charge transporting material, that is, a benzoguanamine resin “Nikalac BL-60” produced by Sanwa Chemical Co., Ltd., are added. The resulting mixture is stirred to form a solution. Then, 0.1 parts by mass of “NACURE 5225” produced by King Industries, Inc. is added to the solution as a curing catalyst. Hereby, a surface protection layer-forming coating liquid is prepared.

The surface protection layer-forming coating liquid is applied to the charge transport layer by dip coating. The resulting coating film is air-dried at room temperature (25° C.) for 30 minutes. Subsequently, in the flow of a nitrogen gas, heating is performed from room temperature to the heating temperature (target temperature) described in Table 1 at an oxygen concentration of 110 ppm and holding is performed during the heating time (holding time) described in Table 1 in order to perform a heat treatment and curing. Hereby, a surface protection layer having a thickness of 10 μm is formed. An electrophotographic photosensitive member is prepared in the above-described manner.

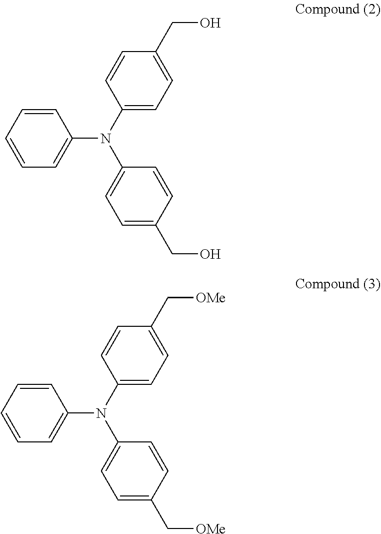

### Examples 2 to 9, Comparative Examples 1 and 2, and Reference Example 1

In Examples 2 to 9, Comparative Examples 1 and 2, and Reference Example 1, an electrophotographic photosensitive member is prepared as in Example 1, except that the thickness of the conductive support and the heating temperature and heating time set in the formation of the surface protection layer are changed as described in Table 1.

### Examples B1 to B9

In Examples B1 to B9, an electrophotographic photosensitive member is prepared as in Example 1, except that the method for forming the surface protection layer is changed as described below and the surface protection layer is changed to “a layer composed of a film formed by curing a composition including an unreactive charge transporting material and a reactive group-containing non-charge transporting material that does not include a charge transporting skeleton and includes a reactive group”.

Formation of Surface Protection Layer B

A surface protection layer composed of a film formed by heat-curing a composition including an unreactive charge transporting material and a reactive group-containing non-charge transporting material that does not include a charge transporting skeleton and includes a reactive group is formed in the following manner.

To 220 parts by mass of cyclopentanone, 85 parts by mass of a compound (4) represented by the structural formula below, which is an unreactive charge transporting material, and 4.4 parts by mass of a curable resin that serves as a reactive group-containing non-charge transporting material, that is, a benzoguanamine resin “Nikalac BL-60” produced by Sanwa Chemical Co., Ltd., are added. The resulting mixture is stirred to form a solution. Then, a suspension containing tetrafluoroethylene resin particles is added to the solution, and the resulting mixture is stirred. Subsequently, a dispersion treatment is repeatedly performed 25 times with a high-pressure homogenizer “YSNM-1500AR” produced by Yoshida Kikai Co., Ltd. equipped with a through-type chamber having a very thin channel while the pressure is increased to 700 kgf/cm². Then, 0.1 parts by mass of “NACURE 5225” produced by King Industries, Inc. is added to the resulting dispersion liquid as a curing catalyst. Hereby, a surface protection layer-forming coating liquid is prepared.

The surface protection layer-forming coating liquid is applied to the charge transport layer by dip coating. The resulting coating film is air-dried at room temperature (25° C.) for 30 minutes. Subsequently, in the flow of a nitrogen gas, heating is performed from room temperature to the heating temperature (target temperature) described in Table 2 at an oxygen concentration of 110 ppm and holding is performed during the heating time (holding time) described in Table 2 in order to perform a heat treatment and curing. Hereby, a surface protection layer having a thickness of 10 μm is formed. An electrophotographic photosensitive member is prepared in the above-described manner.

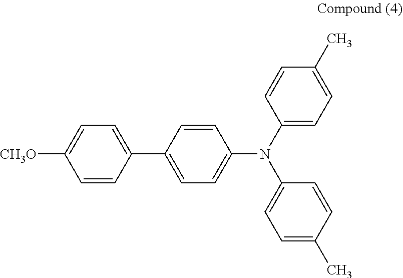

For each of the electrophotographic photosensitive members prepared in Examples, Comparative Examples, and Reference Example above, the degree of cure of the outer periphery-side surface of the surface protection layer, the degree of cure of the conductive support-side surface of the surface protection layer, and the ratio therebetween, are measured by the method described above. Tables 1 and 2 summarize the results. Tables 1 and 2 also list the thickness of the conductive support.

Evaluation of Abrasion Resistance

The initial thickness of the electrophotographic photosensitive member prepared in each example is measured. Then, a modification of “Color 1000 Press” produced by FUJIFILM Business Innovation Corp. which includes an electrostatic image developer is prepared as an image forming apparatus. The electrophotographic photosensitive member of each example is attached to the image forming apparatus. Subsequently, a 50%-halftone image is printed over the entirety of 10 sheets in a 28° C./50% environment. Then, the electrophotographic photosensitive member is removed. The difference between the initial thickness and the thickness of the electrophotographic photosensitive member after the formation of 10 images is measured to determine the amount (μm) of the portion of the surface protection layer which is lost by abrasion. This amount is defined as an initial abrasion loss.

Subsequently, the electrophotographic photosensitive member is again attached to the image forming apparatus and a 50%-halftone image is printed over the entirety of 400,000 sheets in a 28° C./50% environment. Then, the electrophotographic photosensitive member is removed. The difference between the initial thickness and the thickness of the electrophotographic photosensitive member after the formation of 400,000 images is measured to determine the amount (μm) of the portion of the surface protection layer which is lost by abrasion. This amount is defined as a long-term abrasion loss. Tables 1 and 2 list the results. Tables 1 and 2 also list the difference between the initial abrasion loss and the long-term abrasion loss as variations in the abrasion loss over time.

Evaluation of Dot-like Image Defects at Detached Portions

The 10th image formed in the evaluation of abrasion resistance is evaluated in terms of initial image defect with reference to the following criteria. Subsequently, the 400,000th image formed in the evaluation of abrasion resistance is evaluated in terms of long-term image defect with reference to the following criteria. Tables 1 and 2 list the results.

A: Dot-like image defects that are detached portions are absent over the entirety of the image.

B: Dot-like image defects that are slightly detached portions are present in a part of the image, but they are at an acceptable level.

C: Dot-like image defects that are clearly detached portions are present in a part of the image.

C: Dot-like image defects that are detached portions are present in a number of parts of the image.

TABLE 1

| | | | Degree of cure of surface | | | | Abrasion resistance | | | | |
|---|---|---|---|---|---|---|---|---|---|---|---|
| | Surface protection | | protection layer (%) | | | | evaluation | | | | |
| | layer | | Outer | Conductive | Ratio | Thickness of | Initial | Long-term | Difference | Image defect | |
| | Heating | Heating | periphery-side | support-side | (B/A) × | conductive | abrasion | abrasion | (initial − | evaluation | |
| | temperature | time | surface A | surface B | 100 | support | loss | loss | long term) | | Long |
| | (° C.) | (min) | (%) | (%) | (%) | (mm) | (nm/kc) | (nm/kc) | (nm/kc) | Initial | term |
| Example 1 | 155 | 23 | 79.1 | 78.5 | 99.3 | 4 | 1.7 | 1.7 | 0.00 | A | A |
| Example 2 | 158 | 18 | 77.7 | 64.3 | 82.7 | 5 | 1.8 | 3.1 | −1.30 | A | B |
| Example 3 | 155 | 13 | 77.5 | 59.8 | 77.2 | 5 | 1.8 | 3.6 | −1.80 | A | C |
| Example 4 | 180 | 20 | 98.0 | 96.3 | 98.3 | 5 | 1.1 | 1.5 | −0.40 | A | A |
| Example 5 | 110 | 20 | 51.3 | 50.3 | 98.1 | 5 | 2.3 | 2.5 | −0.20 | B | B |
| Example 6 | 180 | 25 | 99.2 | 97.2 | 98.0 | 5 | 0.9 | 1.2 | −0.30 | A | A |
| Example 7 | 110 | 18 | 50.1 | 38.6 | 77.1 | 5 | 3.2 | 3.8 | −0.60 | B | C |
| Example 8 | 155 | 16 | 79.3 | 68.7 | 86.6 | 3 | 1.7 | 2.9 | −1.20 | A | B |
| Example 9 | 155 | 45 | 80.1 | 61.3 | 76.5 | 11 | 1.8 | 3.5 | −1.70 | A | C |
| Comparative | 155 | 8 | 77.2 | 55.8 | 72.3 | 3 | 1.8 | 4.0 | −2.20 | A | D |
| example 1 | | | | | | | | | | | |
| Comparative | 155 | 8 | 70.4 | 43.2 | 61.4 | 5 | 2.2 | 4.6 | −2.40 | A | D |
| example 2 | | | | | | | | | | | |
| Reference | 155 | 16 | 80.1 | 79.1 | 98.8 | 2 | 1.8 | 1.8 | 0.00 | A | A |
| example 1 | | | | | | | | | | | |

TABLE 2

| | | | Degree of cure of surface | | | | Abrasion resistance | | | | |
|---|---|---|---|---|---|---|---|---|---|---|---|
| | Surface protection | | protection layer (%) | | | | evaluation | | | | |
| | layer | | Outer | Conductive | Ratio | Thickness of | Initial | Long-term | Difference | Image defect | |
| | Heating | Heating | periphery-side | support-side | (B/A) × | conductive | abrasion | abrasion | (initial − | evaluation | |
| | temperature | time | surface A | surface B | 100 | support | loss | loss | long term) | | Long |
| | (° C.) | (min) | (%) | (%) | (%) | (mm) | (nm/kc) | (nm/kc) | (nm/kc) | Initial | term |
| Example | 155 | 23 | 80.3 | 79.5 | 99.0 | 4 | 1.7 | 1.7 | 0.0 | A | A |
| B1 | | | | | | | | | | | |
| Example | 158 | 21 | 78 | 63.3 | 81.2 | 5 | 1.8 | 3.2 | −1.4 | A | B |
| B2 | | | | | | | | | | | |
| Example | 155 | 20 | 77.9 | 60.3 | 77.4 | 5 | 1.8 | 3.6 | −1.8 | A | C |
| B3 | | | | | | | | | | | |
| Example | 180 | 20 | 98.4 | 96.2 | 97.8 | 5 | 1.0 | 1.3 | −0.3 | A | A |
| B4 | | | | | | | | | | | |
| Example | 110 | 20 | 52.2 | 50.7 | 97.1 | 5 | 2.3 | 2.5 | −0.2 | B | B |
| B5 | | | | | | | | | | | |
| Example | 180 | 25 | 99.4 | 97.5 | 98.1 | 5 | 0.8 | 1.2 | −0.4 | A | A |
| B6 | | | | | | | | | | | |
| Example | 110 | 18 | 49.8 | 37.2 | 74.7 | 5 | 3.3 | 3.7 | −0.4 | B | C |
| B7 | | | | | | | | | | | |
| Example | 155 | 16 | 79.4 | 69.0 | 86.9 | 3 | 1.7 | 2.7 | −1.0 | A | B |
| B8 | | | | | | | | | | | |
| Example | 155 | 45 | 81.3 | 63.3 | 77.9 | 11 | 1.9 | 3.4 | −1.5 | A | B |
| B9 | | | | | | | | | | | |

As described in Tables 1 and 2, in the electrophotographic photosensitive members prepared in Examples, long-term variations of abrasion resistance are reduced compared with the electrophotographic photosensitive members prepared in Comparative Examples. In addition, it is found that the electrophotographic photosensitive members prepared in Examples 1 to 3 have higher abrasion resistance than the electrophotographic photosensitive members prepared in Examples 4 to 9.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An electrophotographic photosensitive member comprising:
a conductive support having a thickness of 3 mm or more;
a photosensitive layer disposed on the conductive support; and
a surface protection layer disposed on the photosensitive layer,
wherein the surface protection layer is a layer composed of:
a film formed by curing a composition including a reactive group-containing charge transporting material, the reactive group-containing charge transporting material including a reactive group and a charge transporting skeleton in a same molecule; or
a film formed by curing a composition including an unreactive charge transporting material and a reactive group-containing non-charge transporting material, the reactive group-containing non-charge transporting material not including a charge transporting skeleton and including a reactive group, and
wherein a ratio of a degree of cure of a conductive support-side surface of the surface protection layer, the conductive support-side surface facing the conductive support, to a degree of cure of an outer periphery-side surface of the surface protection layer, the outer periphery-side surface serving as an outer periphery of the electrophotographic photosensitive member, is 75% or more.

2. The electrophotographic photosensitive member according to claim 1,
wherein the ratio of the degree of cure of the conductive support-side surface to the degree of cure of the outer periphery-side surface is 80% or more.

3. The electrophotographic photosensitive member according to claim 2,
wherein the ratio of the degree of cure of the conductive support-side surface to the degree of cure of the outer periphery-side surface is 90% or more.

4. The electrophotographic photosensitive member according to claim 1,
wherein the degree of cure of the outer periphery-side surface of the surface protection layer is 55% or more and 95% or less.

5. The electrophotographic photosensitive member according to claim 4,
wherein the degree of cure of the outer periphery-side surface of the surface protection layer is 74% or more and 82% or less.

6. The electrophotographic photosensitive member according to claim 1,
wherein the degree of cure of the conductive support-side surface of the surface protection layer is 41% or more and 95% or less.

7. The electrophotographic photosensitive member according to claim 6,
wherein the degree of cure of the conductive support-side surface of the surface protection layer is 67% or more and 82% or less.

8. The electrophotographic photosensitive member according to claim 1,
wherein the thickness of the conductive support is 4 mm or more and 10 mm or less.

9. A process cartridge detachably attachable to an image forming apparatus, the process cartridge comprising:
the electrophotographic photosensitive member according to claim 1.

10. An image forming apparatus comprising:
the electrophotographic photosensitive member according to claim 1;
a charging unit that charges a surface of the electrophotographic photosensitive member;
an electrostatic latent image forming unit that forms an electrostatic latent image on the charged surface of the electrophotographic photosensitive member;
a developing unit that develops the electrostatic latent image formed on the surface of the electrophotographic photosensitive member with a developer including a toner in order to form a toner image; and
a transfer unit that transfers the toner image onto a surface of a recording medium.
